(19) United States
(12) Patent Application Publication
(10) Pub. No.: US 2002/0073557 A1
(43) Pub. Date: Jun. 20, 2002

(54) Expandable tubular body

(75) Inventor: Yao-Chung Huang, Chang Hua Hsien (TW)

Correspondence Address: Harrison and Egbert, 412 Main Street, 7th Floor, Houston, TX, 77002, US

(73) Assignee: Ho Cheng Garden Tools Co., Ltd.

(21) Appl. No.: 09/739,590

(22) Filed: Dec. 19, 2000

(51) Int. Cl. B25G 1/04

(52) U.S. Cl. 30/341

(57) ABSTRACT

An expandable tubular body is formed of an outer tube, an inner tube slidably fitted into the outer tube, and a device for locating the inner tube and the outer tube. The device is formed of a retaining pin, a press button, and a torsion spring. The inner tube and the outer tube are located in place by the retaining pin which is forced by the press button and the torsion spring to be stopped by the locating edges of the inner tube. The tubular can be expanded by pressing the press button to actuate the retaining pin to move away from the locating edges of the inner tube.

### BACKGROUND OF THE INVENTION

1. Field of the Invention

The present invention relates generally to a tubular body, and more particularly to an expandable tubular body.

2. Description of Related Art

The tree pruner is generally provided with expandable handles which are formed of an inner tube and an outer tube. The inner tube is slidably fitted into the outer tube. The handles are expanded in such a way that the inner tube is extended out of the outer tube, and that the inner tube and the outer tube are located by an eccentric means which is disposed between the inner tube and the outer tube. The conventional locating means is not effective in locating securely the inner tube and the outer tube.

### BRIEF SUMMARY OF THE INVENTION

The primary objective of the present invention is to provide an expandable tubular body with a means to locate securely the inner tube and the outer tube of the expandable tubular body. The inner tube is provided with a plurality of locating edges which are arranged at an interval and are corresponding in location to the locating means. The locating means includes a sleeve, a press button, a torsion spring, and a retaining pin. The inner tube and the outer tube are located securely in place by the retaining pin which is forced by the press button and the torsion spring to be stopped by the locating edges. The expandable tubular body can be expanded by pressing the press button so as to actuate the retaining pin to move away from the locating edges of the inner tube.

### BRIEF DESCRIPTION OF THE SEVERAL VIEWS OF THE DRAWINGS

FIG. 1 shows a perspective view of the present invention.

FIG. 2 shows an exploded view of the present invention.

FIG. 3 shows a longitudinal sectional view of the present invention in combination.

FIG. 4 shows a longitudinal sectional view of the present invention at work.

### DETAILED DESCRIPTION OF THE INVENTION

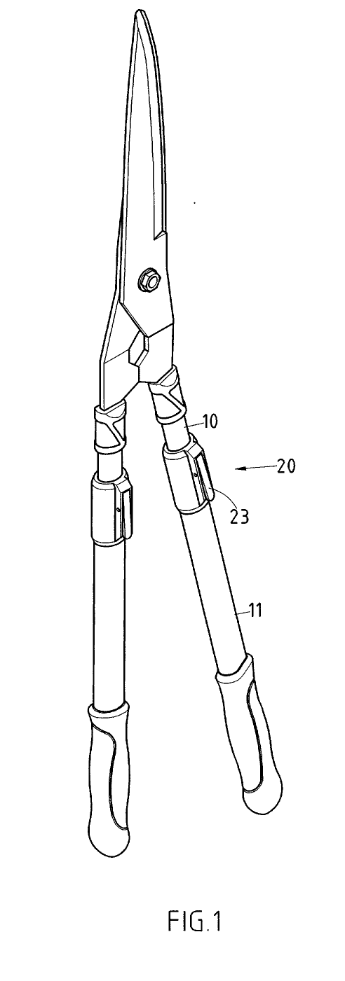

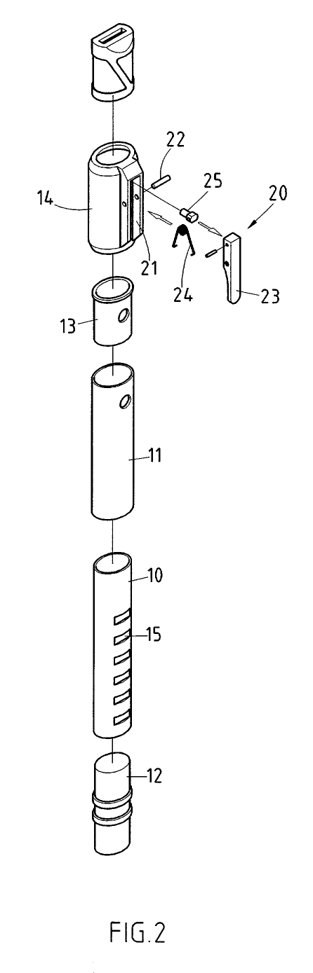

As shown in FIGS. 1-4, an expandable tubular body embodied in the present invention is formed of an inner tube 10, an outer tube 11, and a locating device 20.

The inner tube 10 is slidably fitted into the outer tube 11 and is provided in the outer wall with a plurality locating edges 15, which are arranged at an interval along the longitudinal direction of the inner tube 10. The inner tube 10 is further provided at one end with a stop member 12.

The outer tube 11 is provided at one end with a stop member 13 and a sleeve 14. The stop member 13 of the outer tube 11 and the stop member 12 of the inner tube 10 work together to prevent the inner tube 10 from slipping out of the outer tube 11 at the time when the tubular body of the present invention is expanded. The sleeve 14 is provided with a receiving slot 21.

The locating device 20 is disposed in the receiving slot 21 of the sleeve 14 of the outer tube and is formed of a shaft 22, a press button 23 mounted pivotally on the shaft 22 and provided with a retaining pip 25 pivoted thereto, and a torsion spring 24 for providing the press button 23 with a recovery force.

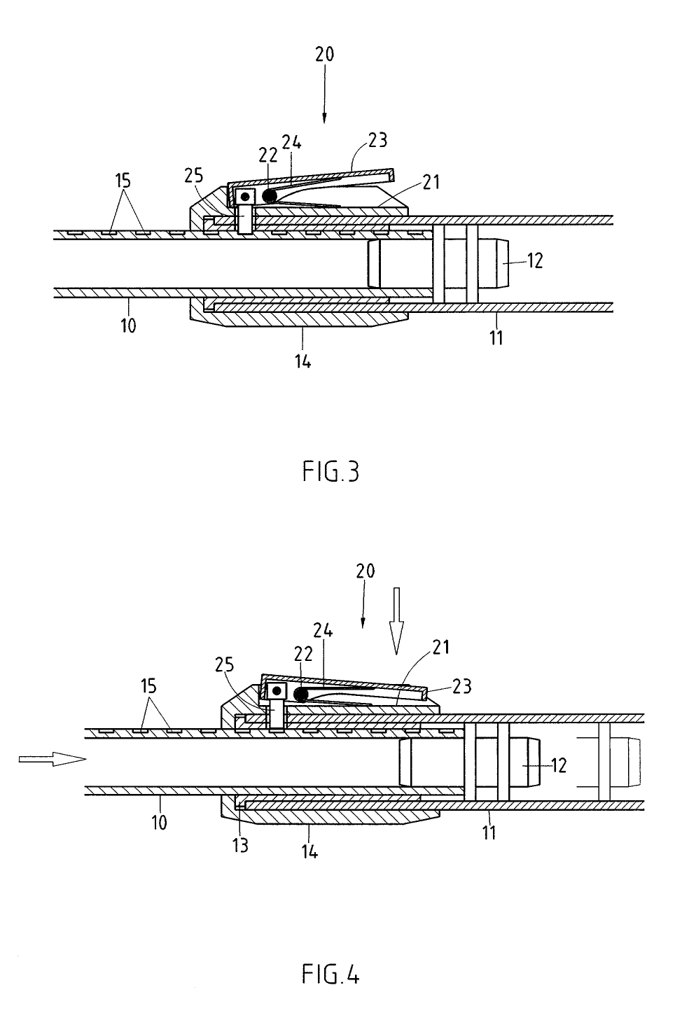

The inner tube 10 and the outer tube 11 are located securely by the retaining pin 25 which is stopped by the locating edge 15 of the inner tube 10 at the time when the retaining pin 25 is acted on by the press button 23 which is in turn urged by the torsion spring 24, as shown in FIG. 3.

As the press button 23 is pressed, the retaining pin 25 of the locating device 20 is actuated to move away from the locating edges 15 of the inner tube 10, thereby enabling the tubular body of the present invention to the expanded, as illustrated in FIG. 4.

The embodiment of the present invention described above is to be regarded in all respects as being merely illustrative and not restrictive. Accordingly, the present invention may be embodied in other specific forms without deviating from the spirit thereof. For example, the inner tube 10 and the outer tube 11 of the tubular body of the present invention have a cross section which may be round, oval, or polygonal. The present invention is therefore to be limited only by the scopes of the following appended claims.

I claim:

1. An expandable tubular body comprising:
an inner tube provided in the outer wall with a plurality of locating edges which are arranged at an interval along the longitudinal direction of said inner tube;
an outer tube slidably fitted over said inner tube and provided with a sleeve which is provided with a receiving slot and is fitted over said outer tube; and
a locating device disposed in said receiving slot of said sleeve of said outer tube and formed of a shaft, a press button mounted pivotally on said shaft and provided with a retaining pin pivoted thereto, and a torsion spring for providing said press button with a recovery force;
said inner tube and said outer tube being located in place by said retaining pin which is acted on by said press button so as to be stopped by said locating edges of said inner tube at such time when said press button is urged by said torsion spring whereby said retaining pin is actuated to move away from said locating edges of said inner tube at the time when said press button is exerted on by an external force, thereby enabling said inner tube and said outer tube to slide in relation to each other.

2. The expandable tubular body as defined in claim 1, wherein said inner tube is provided at one end with a stop member; wherein said outer tube is provided at one end with a stop member which cooperates with said stop member of said inner tube to prevent said inner tube from slipping out of said outer tube at such time when said expandable tubular body is expanded.

3. The expandable tubular body as defined in claim 1, wherein said inner tube and said outer tube have a round cross section.

4. The expandable tubular body as defined in claim 1, wherein said inner tube and said outer tube have an oval cross section.

5. The expandable tubular body as defined in claim 1, wherein said inner tube and said outer tube have a polygonal cross section.
